(19) United States
(12) Patent Application Publication
(10) Pub. No.: US 2003/0160862 A1
(43) Pub. Date: Aug. 28, 2003

(54) Apparatus having cooperating wide-angle digital camera system and microphone array

(76) Inventors: Michael L. Charlier, Palatine, IL (US); Robert A. Zurek, Antioch, IL (US); Thomas R. Schirtzinger, Fontana, WI (US); William L. Reber, Rolling Meadows, IL (US); Christopher B. Galvin, Winnetka, IL (US)

Correspondence Address: MOTOROLA, INC., 1303 EAST ALGONQUIN ROAD, IL01/3RD, SCHAUMBURG, IL, 60196

(21) Appl. No.: 10/083,912

(22) Filed: Feb. 27, 2002

(51) Int. Cl. H04N 7/14

(52) U.S. Cl. 348/14.08; 348/14.02

(57) ABSTRACT

A microphone array (20) senses an audio source (22). An audio processor (34) is responsive to the microphone array (20) to determine a direction (24) of the audio source (22) in relation to a frame of reference (32). The direction (24) comprises an azimuth angle (26) and an altitude angle (30). A wide-angle digital camera system (40) captures at least one wide-angle image. An image processor (44) is responsive to the audio processor (34) to process the at least one wide-angle image to generate at least one perspective corrected image (46) in the direction (24) of the audio source (22).

### BACKGROUND OF THE INVENTION

1. Field of the Invention

The present invention relates to wide-angle digital camera systems and beam-steered microphone arrays.

2. Description of the Related Art

Immersive video technology enables pan, tilt and zoom camera functions to be performed electronically without physically moving a camera. An example of an immersive video technology is disclosed in U.S. Pat. No. 5,185,667 to Zimmermann.

Various applications of immersive video technology have been disclosed in U.S. Pat. Nos. 5,594,935, 5,706,421, 5,894,589 and 6,111,568 to Reber et al. One application of particular interest is teleconferencing using immersive video.

U.S. Pat. No. 5,686,957 to Baker discloses a teleconferencing imaging system with automatic camera steering. The system comprises a video camera and lens system that provides a panoramic image. The system detects the direction of a particular speaker within the panoramic image using an array of microphones. Direction signals are provided to electronically select a portion of the image corresponding to the particular speaker.

In one embodiment, an audio directive component is comprised of four microphones spaced apart and arranged concentrically about the camera and lens system. The above combination is placed on a conference room table so that all participants have audio access to the microphones. Differences in audio signal amplitude obtained from each microphone are detected to determine the closest microphone to a current participant speaker. A point between microphones may be selected as the “closest microphone” using normal audio beam steering techniques. This approach is amenable in teleconferences where a number of participants far exceeds the number of microphones. A segment of the panoramic image which correlates with the “closest microphone” is selected to provide the current speaker's image.

Past related systems have used a table-mounted system that had little or no use for a high pixel density in the center of a 180 degree or 360 degree optical system. This implementation has drawbacks for both teleconference applications and security applications. One drawback is that objects or participants that lie in the same angle around the device as another object, but lie behind the other object, are obstructed from view and/or difficult to separate by the device. This drawback is especially exaggerated in security applications where many of the objects that the user would want to observe are resting on a horizontal surface distributed across a room or an external area. Like in the video domain, separation of audio signals of two persons, one sitting behind another, is problematic.

Further, side conversations are a pariah to teleconferences. Participants are often likely to strike side conversations when all the participants are not present in the same room. Often these side conversations are all that a remote user can hear when the system in use utilizes a distributed microphone array which may have a microphone element in close proximity to parties involved in the side conversation. Also, tabletop mounted systems are prone to noises transmitted through the table by attendees moving materials such as papers, or rapping objects on the table. This vibration coupling of the microphones is difficult to isolate and often has a higher sensitivity than the people talking in the room.

Still further, table mounted teleconferencing systems require an additional document camera when the users desired to share one or more printed documents with remote attendees.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of an embodiment of an immersive audio/video apparatus;

FIG. 2 is a block diagram of another embodiment of an immersive audio/video apparatus;

FIG. 3 is an illustration of an embodiment of an apparatus of either FIG. 1 or FIG. 2;

FIG. 4 illustrates use of an embodiment of an immersive audio/video apparatus in a teleconferencing application;

FIG. 5 illustrates an embodiment of a two-dimensional circular microphone array;

FIG. 6 illustrates an embodiment of a microphone array comprising microphones located at vertices of a truncated icosahedron;

FIG. 7 illustrates an embodiment of a multi-ring microphone array; and

FIG. 8 illustrates a video zooming process.

### DETAILED DESCRIPTION OF THE PREFERRED EMBODIMENTS

Disclosed herein are systems and methods to improve user presence and intelligibility in live audio/video applications such as teleconferencing applications and security monitoring applications. The present disclosure contemplates a directional microphone array that is coupled to either a 180 degree or a 360 degree immersive digital video camera, wherein a direction of an audio event is determinable in at least two degrees of freedom, and a portion of the immersive video in the direction of the audio event is automatically selected and transmitted. Based on its frequency profile, the audio event may further initiate the transmission of an alarm signal.

Further disclosed is an apparatus wherein the directional microphone array is either automatically or manually steered and zoomed to track panning and zooming of an immersive video.

Still further disclosed is a microphone array comprising a plurality of individual microphone elements mounted to a semispherical housing to allow directionality in both an azimuth angle and an altitude angle. In the case of a hemisphere, the microphone array allows accurate beam positioning over an entire hemisphere. The microphone array may be extended to a full spherical array, which is suitable for use with two cameras having hemispherical fields of view.

Embodiments of the apparatus may be either table mounted or mounted overhead. In teleconferencing applications, the device may be mounted slightly above the head level of the tallest attendee. This position allows the visualization and isolation of persons or objects seated behind the first row of attendees. Further, a more cosmetically-acceptable view for the remote user is provided, as he/she is not looking up the noses of the remote participants. Still further, the overhead system allows an image of a document placed on a tabletop to be acquired with a higher density of pixels. Also, the overhead position allows the efficient use of a three-dimensional microphone array to separate these distinct audio sources.

Where prior devices have used either a two-dimensional array or a plethora of single microphones—one for each individual user—a three dimensional array can be used to sense the direction of the source much more efficiently using software-generated compound microphones. This beneficially mitigates the prospect of falsely locating an audio source. By creating a compound microphone that has a beam width limited to the separation between microphone locations, an overlap error that is inherent in selecting a source using single element directional or omnidirectional microphones is mitigated, and preferably eliminated. Further, other useful aspects of the microphone array such as noise reduction of environment and other participants carrying one side conversations can be exploited.

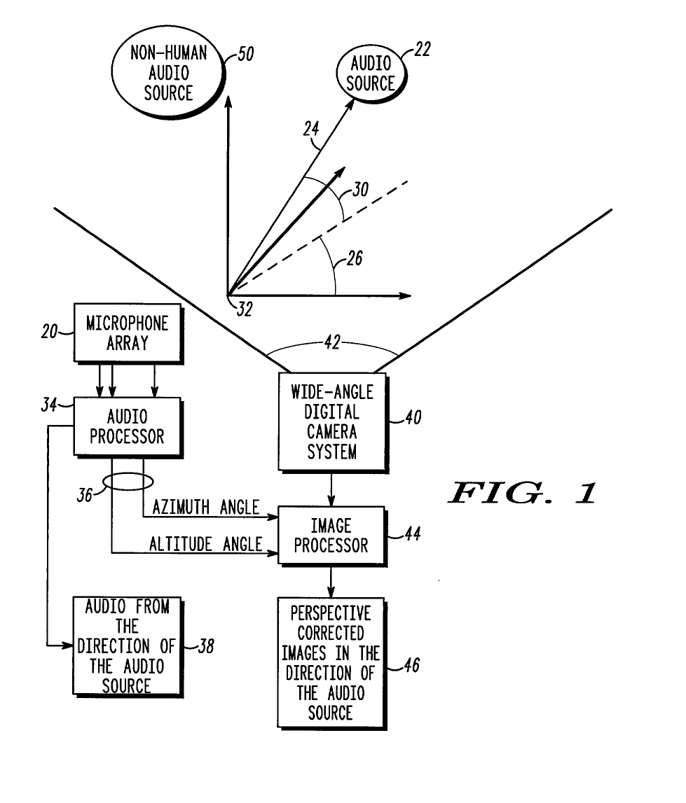

FIG. 1 is a block diagram of an embodiment of an immersive audio/video apparatus. The apparatus comprises a microphone array 20 to sense an audio source 22. The microphone array 20 comprises a sufficient number of microphones arranged in a suitable pattern to sense a direction 24, comprising both an azimuth angle 26 and an altitude angle 30, of the audio source 22 in relation to a frame of reference 32. The microphones may comprises any combination of individually-directional microphones and/or omnidirectional microphones to serve the aforementioned purpose. In this patent application, the term “audio” should be construed to be inclusive of acoustic pressure waves.

An audio processor 34 is responsive to the microphone array 20 to determine the direction 24, comprising both the azimuth angle 26 and the altitude angle 30, of the audio source 22. The audio processor 34 outputs one or more signals 36 indicative of the direction 24. For example, the audio processor 34 may generate a first signal indicating the azimuth angle and a second signal indicating the altitude angle. Alternatively, other quantities based on the azimuth angle and the altitude angle may be outputted by the audio processor 34.

The audio processor 34 outputs an audio signal 38 as sensed by the microphone array 20. The audio processor 34 may process various channels from the microphone array 20 to effectively beam-steer and/or modify a beam width of the microphone array 20 toward the audio source 22. The audio processor 34 may further perform noise reduction acts in generating the audio signal 38.

The apparatus further comprises a wide-angle digital camera system 40. The wide-angle digital camera system 40 has a field of view 42 greater than 50 degrees, and more preferably, greater than 120 degrees. In exemplary embodiments, the field of view 42 ranges from at least 180 degrees to about 360 degrees. The wide-angle digital camera system 40 may include an optical element such as a fisheye lens which facilitates all objects in the field of view 42 being substantially in focus. However, many other wide-angle lenses using either traditional optics or holographic elements are also suitable for this application.

Alternatively, the wide-angle digital camera system 40 may comprise a convex mirror to provide the wide-angle field of view 42.

The wide-angle digital camera system 40 captures at least one, and preferably a sequence of wide-angle images. The wide-angle images include images of the audio source 22. Depending on its location, the audio source 22 may be located anywhere within the wide-angle images.

An image processor 44 is responsive to the audio processor 34 and the wide-angle digital camera system 40. The image processor 44 processes one or more wide-angle images to generate at least one, and preferably a sequence of perspective corrected images 46 in the direction 24 of the audio source 22. The image processor 44 selects a portion of the wide-angle images based on the direction signals 36 so that the audio source 22 is about centered therein, and corrects the distortion introduced by the wide-angle optical element(s) for the portion. Thus, the perspective corrected images 46 include an image of the audio source 22 about centered therein regardless of the azimuth angle 26 and the altitude angle 30. The perspective corrected images 46 may be outputted either to a display device for viewing same, to a mass storage device for storing same, or to a transmitter for remote viewing or storage.

The audio processor 34 may determine the direction 24 of a greatest local amplitude in a particular audio band. For teleconferencing applications, the particular audio band may comprise a human voice band. Considering the audio source 22 to be a human voice source, for example, the audio processor 34 filters signals from the microphone array 20 to attenuate non-human-voice audio sources 50 (e.g. an air conditioning system) with respect to the audio source 22. Thus, even if the non-human-voice audio sources 50 have a greater amplitude than the audio source 22, the greatest amplitude in the particular audio band would correspond to the audio source 22.

Either in addition to or as an alternative to the aforementioned direction-determining approach, the audio processor 34 may determine the direction 22 based on a limited-duration audio event. Examples of limited-duration audio events include, but are not limited to, a gun shot, glass breaking and a door being battered. In these and other cases, the image processor 44 may process the wide-angle images to generate the perspective corrected images 46 in the direction 24 after the limited-duration audio event has ended. Limited-duration audio events are typical in security applications.

In addition to determining the direction 24, the audio processor 34 may compare a profile of the audio source 22 to a pre-stored profile. The comparison may be performed in a time domain and/or a frequency domain. Preferably, a wavetable lookup is performed to compare the profile of the audio source 22 to a plurality of pre-stored profiles. If the profile of the audio source 22 sufficiently matches one of the pre-stored profiles, the audio processor 34 may initiate an action such as transmitting an alarm signal. The alarm signal augments the perspective corrected image 46 corresponding to the direction 24 of the audio source 22. The use of profile comparisons is well-suited for security applications, wherein a gun shot profile, a glass-breaking profile, and other security event profiles are pre-stored.

Profile comparisons may be either inclusionary or exclusionary in nature. For an inclusionary pre-stored profile, the action is initiated if the profile sufficiently matches the pre-stored profile. For an exclusionary pre-stored profile, the action is inhibited if the profile sufficiently matches the pre-stored profile. The use of exclusionary pre-stored profiles is beneficial to mitigate occurrences of false alarms. For example, if a specific sound, such as thunder associated with a lighting bolt, causes an undesired initiation of the alarm, a user may actuate an input device (e.g. depress a button) to indicate that the specific sound should be stored as an exclusionary pre-stored profile. As a result, subsequent thunder events would not initiate the alarm.

The microphone array 20, the audio processor 34, the wide-angle digital camera system 40 and the image processor 44 may be housed in a single unit. Alternatively, the microphone array 20 and the wide-angle digital camera system 40 are collocated in a capture unit, and the audio processor 34 and the image processor 44 are collocated in a processing unit. In this case, the capture unit may comprise a wireless transmitter and the processor unit may comprise a wireless receiver. The transmitter and receiver provide a wireless link to transmit audio signals from the microphone array 20 to the audio processor 34, and wide-angle image signals from the wide-angle digital camera system 40 to the image processor 44.

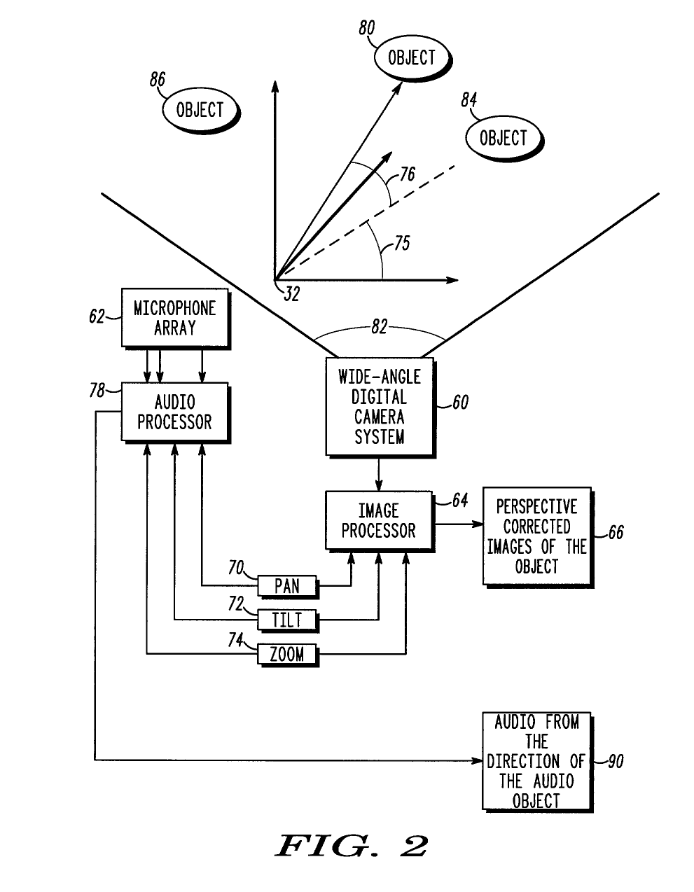

FIG. 2 is a block diagram of another embodiment of an immersive audio/video apparatus. The apparatus comprises a wide-angle digital camera system 60, such as the wide-angle digital camera system 40, and a microphone array 62, such as the microphone array 20. An image processor 64 processes one or more wide-angle images from the wide-angle digital camera system 60 to generate one or more perspective corrected images 66. The portion of the wide-angle images used to define the perspective corrected images is defined by a plurality of parameters. Examples of the parameters include a pan parameter 70, a tilt parameter 72, and a zoom parameter 74. The center of the portion is defined by the pan parameter 70 and the tilt parameter 72. The pan parameter 70 indicates an angle 75 along a first plane, such as a horizontal plane, and the tilt parameter 72 indicates an angle 76 along a second plane, such as a vertical plane. The width of the portion is defined by the zoom parameter 74. The parameters may be provided by a user interface, or by the output of a processor. A user, such as either a content director or a viewer, adjusts the parameters using the user interface. A content director can use the apparatus to create content such as movies, sporting event content and theater event content.

An audio processor 78 is responsive to the microphone array 62 to modify a directionality of the microphone array 62 to correspond to the portion of the wide-angle image defined by the parameters. The directionality may be modified based on the pan parameter 70 and the tilt parameter 72. The audio processor 78 may further cooperate with the image processor 64 to effectively modify a beam width of the microphone array 62 based on the zoom parameter 74.

Consider an object 80, which may be a window in security applications or a human in teleconferencing applications, within a field of view 82 of the wide-angle digital camera system 60. The pan parameter 70 and the tilt parameter 72 may be provided to center the object 80 within the perspective corrected images 66. The zoom parameter 74 may be provided to exclude other objects 84 and 86 from the perspective corrected images 66.

Using the pan parameter 70 and the tilt parameter 72, the audio processor 78 processes signals from the microphone array 62 to effectively steer toward the object 80. Using the zoom parameter 74, the audio processor 78 may process signals from the microphone array 62 to vary a beam width about the object 80. Thus, the audio processor 78 produces an audio output 90 which senses audio produced at or near the object 80.

Similar to the apparatus described with reference to FIG. 1, the elements described with reference to FIG. 2 may be contained in a single unit, or in capture and processing units having a wireless link therebetween.

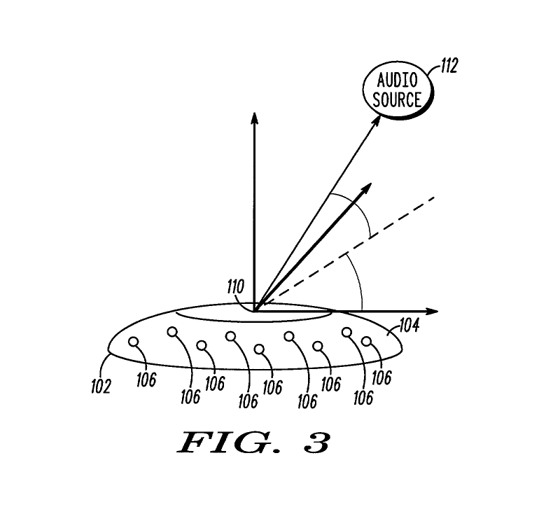

FIG. 3 is an illustration of an embodiment of an apparatus of either FIG. 1 or FIG. 2. The apparatus comprises a housing 100 having a base 102 and a dome-shaped portion 104. The base 102 is suited for support by or mounting to a flat surface such as a table top, a wall, or a ceiling. The dome-shaped portion 104 may be substantially semispherical or have an alternative substantially convex form. As used herein, the term semispherical is defined as any portion of a sphere, including but not limited to a hemisphere and an entire sphere. Substantially semispherical forms include those that piecewise approximate a semisphere.

The microphone array comprises a plurality of microphones 106 disposed in a semispherical pattern about the dome-shaped portion 104. The microphones 106 may be arranged in accordance with a triangular or hexagonal packing distribution, wherein each microphone is centered within a corresponding one of a plurality of spherical triangles or hexagons.

The housing 100 houses and/or supports the wide-angle digital camera system. The wide-angle digital camera system has a hemispherical field of view emanating about at a peak 110 of the dome-shaped portion 104. The housing 100 may further house the wireless transmitter described with reference to FIG. 1, or the audio processor (34 or 76) and the image processor (44 or 64).

Incorporating the functionality of FIG. 1, the embodiment of FIG. 3 is capable of detecting an audio source 112 anywhere within the hemispherical field of view, determining the direction of the audio source, and generating a perspective corrected image sequence of the audio source. Incorporating the functionality of FIG. 2, the embodiment of FIG. 3 is capable of panning and zooming wide-angle images to a specific target anywhere within the hemispherical field of view, and automatically having the audio output track the specific target.

FIG. 4 illustrates use of an embodiment of an immersive audio/video apparatus in a teleconferencing application. At one location 150, a capture unit 152, such as the one shown in FIG. 3, is preferably mounted overhead of a first person 156, a second person 158 and a third person 160. The capture unit 152 may be mounted to a ceiling by an extendible/retractable member (not specifically illustrated) such as a telescoping member. Using the member, the capture unit 152 can be deployed down to nearly head level when being used, and returned up toward the ceiling when not being used for a teleconference (but possibly being used for a security application). As an alternative to overhead mounting, a capture unit 152′ may be placed on a table 154. For purposes of illustration and example, the first person 156 is standing by the table 154, and the second person 158 and the third person 160 are seated at the table 154.

The capture unit 152 wirelessly communicates a plurality of audio signals and a sequence of wide-angle images having a hemispherical field of view to a processing unit 162. During the course of the teleconference, the processing unit 162 detects the directions of the persons 156, 158 and 160 with respect to the capture unit 152. The processing unit 162 outputs three perspective-corrected image sequences: a first sequence of the person 156, a second sequence of the person 158 and a third sequence of the person 160.

The processing unit 162 communicates the image sequences, along with the sensed audio, to a computer network 164. Examples of the computer network 164 include, but are not limited to, an internet, an intranet or an extranet.

At another location 170, a fourth person (not illustrated) is seated at his/her personal computer 174. The computer 174 receives the image sequences and the audio via the computer network 164. The computer 174 includes a display 176 which simultaneously displays the three image sequences in three display portions 180, 182 and 184. The display portions 180, 182 and 184 may comprise windows, panes, or alternative means of display segmentation.

Even though the three persons 156, 158 and 160 have significantly different distances below the capture unit 152, each person's image is centered within his/her corresponding image sequence since the units 152 and 162 are capable of locating audio sources with at least two degrees of freedom. To reduce background noise, the processing unit 162 may steer the microphone array toward one or more persons who are speaking at the time.

To reduce bandwidth requirements, the processing unit 162 may transmit the different perspective corrected image sequences using different frames rates. A higher frame rate is used for a speaking participant in contrast to a non-speaking participant, as sensed by the microphone array. Image sequences of speaking participants may be transmitted in a video mode of greater than or equal to 15 frames per second, for example. Image sequences of non-speaking participants may comprise still images which are transmitted at a significantly slower rate. The still images may be periodically refreshed based on a time constant and/or movement detected visually using the processing unit 162.

Optionally, image mapping techniques such as face detection may be used to sense the location of the persons 156, 158, and 160 at all times during the call. Each person's face may be substantially centered within an image stream using the results of the image mapping. Image mapping may comprise visually determining one or more persons who are speaking. Image mapping may be used to track persons while they are not speaking. To reduce background noise, the processing unit 162 may steer the microphone array toward one or more persons who are speaking at the time.

The capture unit 152 can be made to mount anywhere due to its size and the inclusion of a one-way wireless link to a processing unit. Since all of the audio and video processing is performed in the processing unit 162, the capture unit 152 serves its purpose by transmitting a continuous stream of audio from each microphone channel and wide-angle video. The wireless link may comprise a BLUETOOTH link, an 802.11(b) link, a wireless telephone link, or any other secure or non-secure link depending on the specific application.

The ceiling mount or other overhead orientation of the capture unit 152 allows the center of the camera to be used as a document camera. A higher density of pixels in the center is used to resolve the fine detail required to transmit an image of a printed document. For example, the capture unit 152 and the processing unit 162 may cooperate to provide one or more perspective corrected images of a hard copy document 186 on the table 154. The display 176 displays the one or more images in a display region 190.

A more detailed description of various embodiments of the microphone arrays (20 and 62) is provided hereinafter. In a fully spherical microphone array application, microphones are placed in diametrically-opposed positions equally spaced about a sphere. The microphones are positioned both equidistantly and symmetrically about each individual microphone. All microphones have the same arrangement of microphones around them, i.e. there is not one number of microphones immediately surrounding some locations and a different number of microphones immediately surrounding another location.

Certain three-dimensional geometric figures approximate a sphere in such a way at either the center of their faces or their vertices. The simplest ones of these figures include the tetrahedron and the cube. However, these two figures have an insufficient microphone density to allow adequate zooming of the microphone beam. Figures such as the dodecahedron, the icosahedron, and the truncated icosahedron follow the prescribed location rules and allow for robust compound microphone creation.

In the spherical case, there are 2n microphones in the system, where n is an integer greater than zero. This combined with directional cardioid microphones at each face or vertex allows for the creation of definable main beam widths with nearly nonexistent side lobes. This is possible because a summation of opposing microphones creates an omnidirectional microphone, and a difference of said microphones creates an acoustic dipole. These compound omnidirectional and dipole microphones are used as building blocks for higher-order compound microphones used in the localized playback of the system. When a sufficient number of microphones is used in such a system, a beam can be formed in software that not only has significant reduction outside of its bounds, but also can maintain a constant beam width while being steered at any angle between neighboring microphones. Thus, the entire sphere can be covered with equal precision and reduction in acoustic signals emanating from sources outside of its beamwidth.

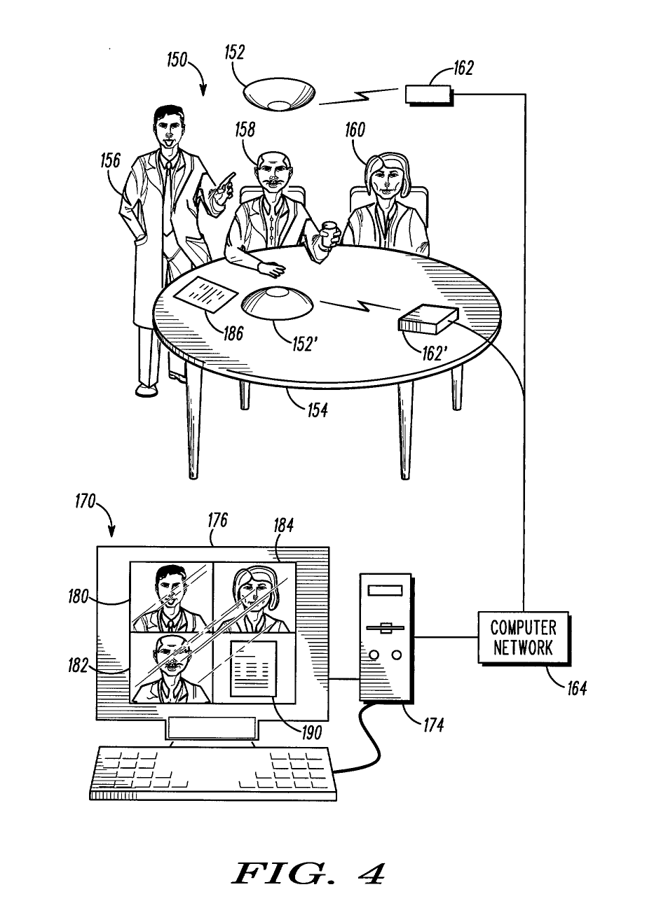

The aforementioned orientations of microphones on a sphere allow for a higher-order compound microphone that can be defined as a relationship of the difference of two on-axis microphones times the nearest on-axis microphone, multiplied by the same relation for each of the nearest equidistant microphone pairs. In the case of a two-dimensional circular array (an example of which being shown in FIG. 5), this expression reduces to m1(c1*m1−m2)*m3(c2*m3−m4)*m5(c3*m5−m6), where m1 to m8 represent eight microphone elements, and cn are constants that determine the direction of the beam relative to an axis 200 defined through microphones m1 and m2. The first compound element comprised of the m1 and m2 microphone elements is a variation of a second-order cardioid. The second term, which is comprised of the elements m3, m4, m5 and m6, are the closest surrounding pairs. If one wishes to further increase the order of the compound microphone, the next closest sets of pairs would be included with their sets of coefficients cn until the order of the array is reached. In this way, the zoom function of the microphone array may be practiced.

The lowest order zoom function is a cardioid microphone closest to the source. The next level is a second-order modified cardioid directed at the source. The next level is an order involving all of the adjacent microphone pairs as shown above for the two-dimensional circular array. This process may be continued using expanding layers of equidistant microphones until a desired level of isolation is achieved.

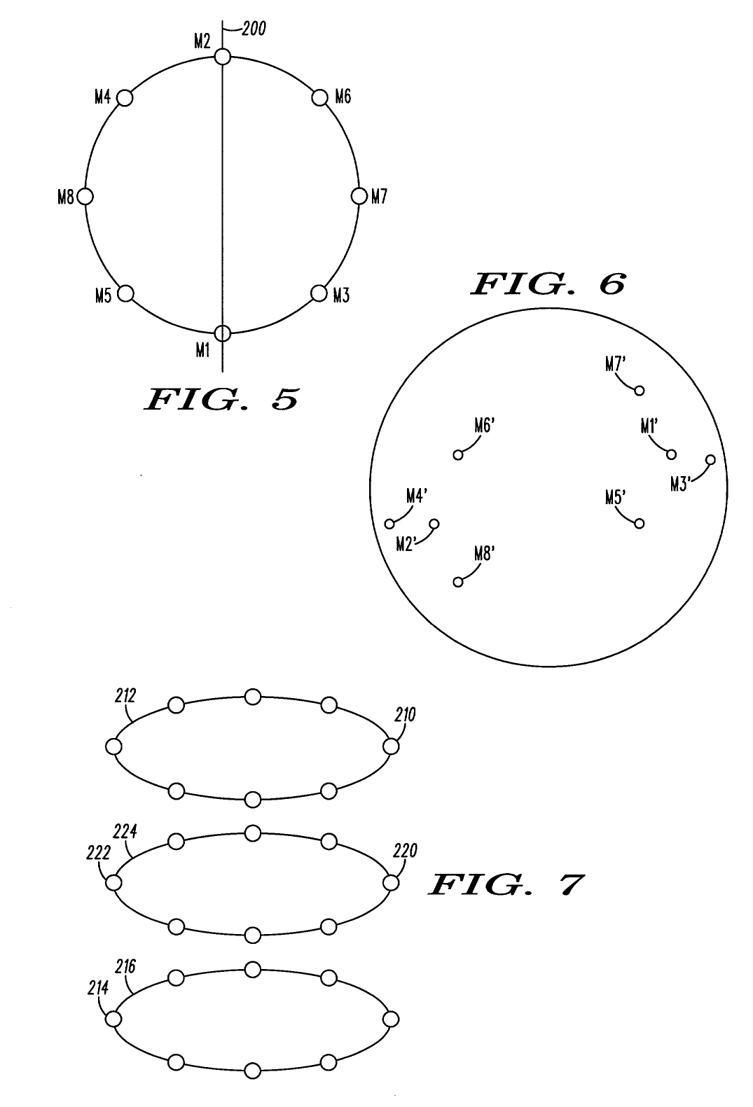

FIG. 6 shows an example of microphones m1′ to m8′ located at vertices of a truncated icosahedron whose edges are all the same size (e.g. a bucky ball). For this configuration, the form of the higher-order compound beaming function is defined as follows: m1′(c1′*m1′−m2′)*m3′(c2′*m3′−m4′)*m5′(c3′*m5′-m6′)*m7′(c4′*m7′−m8′). In the case of a truncated icosahedron, the first adjacent ring of equidistant microphones contains three microphone pairs. The second ring of nearly equidistant microphones would contain 6 pairs, and so on. The variation of the coefficients cn′ effectively steers the beam to any angle in altitude or azimuth with nearly constant beamwidth given the proper values of the cn's and using the closest microphone as ml.

An implementation of this type of system using a half sphere would incorporate half the microphones used in the full sphere plus one additional omnidirectional microphone. The same placement rules are used for the half sphere as in the full sphere. With the addition of the single omnidirectional microphone, the same level of processing is available for beam direction and manipulation. An equivalent dipole microphone can be provided by subtracting an individual cardioid from the omnidirectional microphone. The same series of caridioid times dipole is possible by merely changing the series to m1*(c1*m0−m1)*m3(c2*m0−m3)*m5(c3*m0−m5)*m7*(c4*m0−m7), where m0 is the omnidirectional microphone.

The array can also be reduced to two or more rings of microphones mounted around the base of the camera and processed similar to the two-dimensional array in FIG. 5 except in azimuth and a small arc of altitude. This technique has a limited range of vertical steering, but maintains the horizontal range and precision. An example of such an array of coaxial and non-concentric rings is shown in FIG. 7. The microphone pairs are defined by matching a microphone 210 on a top ring 212 of the unit with a diametrically opposed microphone 214 on a bottom ring 216. If the array consists of an odd number of rings, a pair of diametrically opposed microphones 220 and 222 in a center ring 224 are employed.

Automatic acoustic-based steering of the microphone array 20 and wide-angle digital camera system 40 in FIG. 1 may be accomplished by first examining a frequency-band-limited amplitude of each of a series of compound microphones whose beam axis lies on an axis through each microphone capsule, and whose beam width is equal to an angular distance between an on-axis microphone and a nearest neighbor microphone. This beam can be achieved by combining signals produced by an on-axis microphone pair and a closest ring of accompanying microphone pairs. This process mitigates, and preferably eliminates, the possibility of false images due to microphone overlap as previously discussed.

The next step includes comparing the output of several newly-created virtual compound microphones spaced within an area of the original compound beam. Each of the resulting beams have the same beam width as the original compound beam, thus allowing overlap between the new beams. Once the audio source 22 is known to be within the initial beam, the overlap of subsequent beams can be used to very accurately locate the audio source 22 within the solid angle of the original beam.

Once the audio source 22 is located, the beam can be narrowed by including the next closest ring of equidistant microphones. This iterative process occurs over time, resulting in a reduced initial computation time and a visual and audible zooming on a subject as he/she speaks.

By including an automatic gain control circuit or subroutine which follows the audio processing, the effect of the audible zoom is to reduce other audible noise while the speaker's voice level remains about constant. The audio zoom process proceeds as described earlier by beginning with the cardioid signal closest to the audio source 22, switching to the second-order cardioid, and then to higher-order steered beams aimed at the audio source 22 as time progresses.

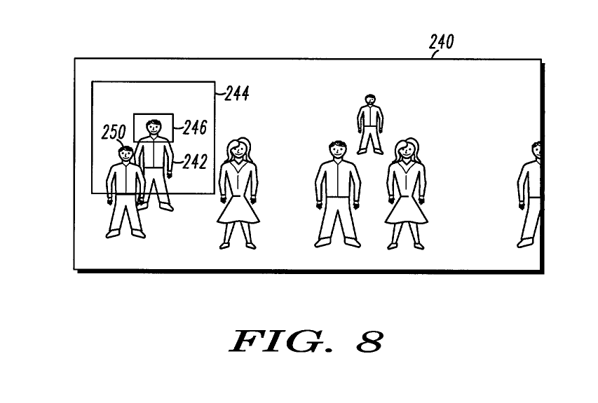

The video follows a similar zooming process, as illustrated in FIG. 8. The image processor 44 initially generates a perspective corrected image sequence of a quadrant 240 which includes an audio source (e.g. a human 242 that is speaking). Gradually, the image processor 44 generates a perspective corrected image sequence of a smaller portion 244 which includes the human 242. Thereafter, the image processor 44 generates a perspective corrected image sequence of an even smaller portion 246 which provides a head-and-shoulder shot of the human 242. The gradual, coordinated zooming of the audio and video signals act to reduce a so-called “popcorn” effect of switching between two very different zoomed-in audio and video sources, especially if the two sources are physically near each other.

An alternative implementation of the auto-tracking feature comprises using the first step of the above-described audio location method to find a general location of the subject. Referring to FIG. 8, the general location of the human 242 is determined to be within the portion 244. Center coordinates of the general location are communicated to the image processor 44.

A video mapping technique is used to identify all the possible audio sources within the general location. In this example, the human 242 and a non-speaking human 250 are possible audio sources within the general location indicated by the portion 244. Coordinates of these possible sources are fed back to the audio processor 34. The audio processor 34 determines which of the potential sources is speaking using virtual compound microphones directed at the potential sources. Once the audio source is identified, the audio processor 34 sends the coordinates of the audio source to the image processor 64. The audio processor 34 also manipulates the incoming audio data stream to focus the beam of the microphone array 62 on the coordinates of the head of the human 242. This process utilizes a gradual zooming technique as described above.

Embodiments of the herein-disclosed inventions may be used in a variety of applications. Examples include, but are not limited to, teleconferencing applications, security applications, and automotive applications. In automotive applications, the capture unit may be mounted within a cabin of an automobile. The capture unit is mounted to a ceiling in the cabin, and located to obtain wide-angle images which include a driver, a front passenger, and any rear passengers. Any individual in the automobile may use the apparatus to place calls. Audio beam steering toward the speaking individual is beneficial to reduce background noise. In security and other applications, the capture unit may be autonomously mobile. For example, the capture unit may be mounted to a movable robot for an airport security application.

It will be apparent to those skilled in the art that the disclosed inventions may be modified in numerous ways and may assume many embodiments other than the preferred forms specifically set out and described herein. For example, in contrast to a three-dimensional pattern, the microphones in the microphone array may be arranged in a two-dimensional pattern such as one shown in FIG. 5. In this case, microphone array may comprise a ring of microphones disposed around the base of the capture unit. This configuration would allow precise positioning of the transmitting audio source in the azimuth angle, but would not discriminate to the same extent in the altitude angle. Further, the wide-angle digital camera system may be sensitive to non-visible light, such as infrared light, in contrast to visible light. Still further, the wide-angle digital camera system may have a low-light mode to capture images with a low level of lighting.

Yet still further, the herein-described profile comparisons may be used to automatically recognize a person's voice. Upon recognizing a person's voice, textual and/or graphical information indicating the person's name, title, company, and/or affiliation may be included as a caption to his/her images.

As an alternative to displaying images of a hard copy document in the display region 190, computer-generated images may be displayed in the display region 190. For example, a word processing document may be shown in the display region 190 for collaborative work by the participants. Alternatively, computer-generated presentation slides may be displayed in the display region 190. Other collaborative computing applications are also enabled using the display region 190.

The herein-disclosed capture units may be powered in various ways, including but not limited to, mains power, a rechargeable or non-rechargeable battery, solar power or wind-up power.

The herein-disclosed processing units may be either integrated with or interfaced to a wireless mobile telephone, a set-top box, a cable modem, or a general purpose computer, to remotely communicate images and audio. Alternatively, the herein-disclosed processing units may be integrated with a circuit card that interfaces with either a wireless mobile telephone, a set-top box, a cable modem, or a general purpose computer, to remotely communicate images and audio. Similarly, the images and audio generated by the processing unit may be remotely received by a wireless mobile telephone, a set-top box, a cable modem, or a general purpose computer.

Accordingly, it is intended by the appended claims to cover all modifications which fall within the true spirit and scope of the present invention.

What is claimed is:

1. An apparatus comprising:
a microphone array to sense an audio source;
an audio processor responsive to the microphone array to determine a direction of the audio source in relation to a frame of reference, the direction comprising an azimuth angle and an altitude angle;
a wide-angle digital camera system; and
an image processor responsive to the audio processor
and the wide-angle digital camera system, the image processor to process at least one wide-angle image from the wide-angle digital camera system to generate at least one perspective corrected image in the direction of the audio source.

2. The apparatus of claim 1 further comprising a housing having a base and a dome-shaped portion, wherein the wide-angle digital camera system has a field of view emanating about at a peak of the dome-shaped portion.

3. The apparatus of claim 2 wherein microphone array comprises a plurality of microphones disposed about the dome-shaped portion.

4. The apparatus of claim 1 wherein the microphone array comprises a plurality of microphones disposed in a substantially semispherical three-dimensional pattern.

5. The apparatus of claim 1 wherein the microphone array comprises a first ring of microphones and at least a second ring of microphones, the first ring coaxial to and non-concentric with the second ring.

6. The apparatus of claim 1 wherein the audio processor is to determine the direction of a greatest local amplitude in a particular audio band.

7. The apparatus of claim 1 wherein the audio processor is to determine the direction of a limited-duration audio event, and wherein the image processor is to process a plurality of wide-angle images from the wide-angle digital camera system to generate a plurality of perspective corrected images in the direction after the limited-duration audio event has ended.

8. The apparatus of claim 1 wherein the image processor is to generate a first perspective corrected image sequence of a portion of the at least one wide-angle image in the direction of the audio source, and thereafter to generate a second perspective corrected image sequence of a smaller portion of the at least one wide-angle image in the direction of the audio source.

9. The apparatus of claim 1 wherein the audio processor is to determine the direction by comparing virtual outputs of each of a series of virtual compound microphones formed using the microphone array.

10. The apparatus of claim 1 wherein the image processor is to locate a plurality of possible audio sources from the at least one wide-angle image, and wherein the audio processor is responsive to the image processor to identify which of the possible audio sources is the audio source as sensed by the microphone array.

11. The apparatus of claim 1 wherein the wide-angle digital camera system has at least a 180 degree field of view.

12. The apparatus of claim 1 wherein the wide-angle digital camera system has about a 360 degree field of view.

13. The apparatus of claim 1 further comprising:
a wireless transmitter associated with the microphone array and the wide-angle digital camera system; and
a wireless receiver associated with the audio processor and the image processor;
wherein the audio processor is responsive to the microphone array via a wireless link provided between the wireless transmitter and the wireless receiver, and wherein the image processor is responsive to the wide-angle digital camera system via the wireless link.

14. The apparatus of claim 1 wherein the audio processor is to compare a profile of the audio source to a plurality of pre-stored profiles, and to initiate an alarm signal in response to a match of the profile to one of the pre-stored profiles.

15. The apparatus of claim 1 wherein the audio source is a human, wherein the audio processor is to compare a profile of the audio source to a plurality of pre-stored profiles to recognize the human, and wherein the image processor is responsive to the audio processor to augment the perspective corrected image with information identifying the human.

16. An apparatus comprising:
a housing having a dome-shaped portion;
a microphone array comprising a plurality of microphones disposed about the dome-shaped portion; and
a wide-angle digital camera system supported by the housing.

17. The apparatus of claim 16 wherein the wide-angle digital camera system has a field of view emanating about at a peak of the dome-shaped portion.

18. The apparatus of claim 16 wherein the plurality of microphones are disposed in a substantially semispherical three-dimensional pattern.

19. The apparatus of claim 16 wherein the microphone array comprises a ring of microphones.

20. The apparatus of claim 16 wherein the microphone array comprises a first ring of microphones and a second ring of microphones, the first ring coaxial to and non-concentric with the second ring.

21. The apparatus of claim 16 further comprising:
an audio processor responsive to the microphone array and housed by the housing; and
an image processor responsive to the audio processor and housed by the housing.

22. The apparatus of claim 16 further comprising:
an audio processor;
a video processor;
a wireless transmitter associated with the microphone array and the wide-angle digital camera system; and
a wireless receiver associated with the audio processor and the image processor; wherein the audio processor is responsive to the microphone array via a wireless link provided between the wireless transmitter and the wireless receiver, and wherein the image processor is responsive to the wide-angle digital camera system via the wireless link.

23. The apparatus of claim 16 wherein the wide-angle digital camera system has at least a 180 degree field of view.

24. The apparatus of claim 16 wherein the wide-angle digital camera system has about a 360 degree field of view.

25. An apparatus comprising:
a wide-angle digital camera system to capture at least one wide-angle image;
an image processor to generate at least one perspective corrected image of a portion of the at least one wide-angle image;
a microphone array; and
an audio processor which cooperates with the image processor to modify a directionality of the microphone array to correspond to the portion of the at least one wide-angle image.

26. The apparatus of claim 25 wherein the audio processor cooperates with the image processor to modify a beam width of the microphone array to correspond to the portion of the at least one wide-angle image.

27. The apparatus of claim 26 wherein the audio processor is to modify the beam width by modifying an order of a virtual compound microphone formed using the microphone array.

28. The apparatus of claim 26 wherein the portion is defined by a pan parameter and a zoom parameter, wherein the audio processor cooperates with the image processor to modify the directionality based on the pan parameter and to modify the beam width based on the zoom parameter.

29. The apparatus of claim 28 wherein the portion is further defined by a tilt parameter, wherein the audio processor cooperates with the image processor to modify the directionality based on the tilt parameter.

30. An apparatus comprising:
a wide-angle digital camera system mounted above participants of a teleconference to capture at least one wide-angle image of the participants and of a hard copy document; and
an image processor to generate at least one perspective-corrected image of a first portion of the at least one wide-angle image which includes the hard copy document, and to generate at least one perspective-corrected image of a second portion of the at least one wide-angle image which includes at least one of the participants.

31. The apparatus of claim 30 wherein the wide-angle digital camera is ceiling-mounted.

32. The apparatus of claim 31 wherein the wide-angle digital camera is ceiling-mounted by a member which allows the wide-angle digital camera to have an adjustable vertical position.

33. An apparatus comprising:
a microphone array to sense an audio source; and
an audio processor responsive to the microphone array to determine a direction of the audio source in relation to a frame of reference, to modify a directionality of the microphone array to correspond to the direction, and to modify a beam width of the microphone array.

34. The apparatus of claim 33 wherein the audio processor is to modify the beam width by modifying an order of a virtual compound microphone formed using the microphone array.

35. The apparatus of claim 33 wherein the audio processor is to determine the direction by comparing virtual outputs of each of a series of virtual compound microphones formed using the microphone array.

36. The apparatus of claim 33 wherein the plurality of microphones are disposed in a substantially semispherical three-dimensional pattern.

37. The apparatus of claim 33 wherein the microphone array comprises a first ring of microphones and at least a second ring of microphones, the first ring coaxial to and non-concentric with the second ring.

38. The apparatus of claim 33 wherein the direction comprises an azimuth angle and an altitude angle.
